(19) United States
(12) Patent Application Publication
(10) Pub. No.: US 2023/0236085 A1
(43) Pub. Date: Jul. 27, 2023

(54) Non Rotating Lens Centering Device

(71) Applicant: Oren Aharon, Haifa (IL)

(72) Inventor: Oren Aharon, Haifa (IL)

(21) Appl. No.: 17/584,433

(22) Filed: Jan. 26, 2022

(51) Int. Cl. G01M 11/02; G02B 27/30; G02B 27/10; G02B 7/02

(52) U.S. Cl. CPC G01M 11/0207; G02B 27/30; G02B 27/106; G02B 7/02; G01M 11/0221

(57) ABSTRACT

The present invention provides an apparatus and method for optical centering of lenses, potentially to be used for automatic accurate alignment and bonding of said lenses into an imaging system. The non-rotating lens centering device includes a motorized focusing autocollimator, one or two aiming lasers coupled to the motorized focusing autocollimator, and an optical laser redirector such as retro-reflectors or beam splitters and mirrors. The system may comprise an imaging device for alignment and beam profiling, a computer device and algorithms for data analysis to provide information related to centering offsets to be corrected. Motorized correcting system will realign and eliminate the unwanted decentering and adjustment of the lens.

### BACKGROUND OF THE INVENTION

### 1. Field of Invention

Our field of the invention relates to optimization of optical alignment for lenses which will enable accurate cost-effective production of optical systems. The main purpose of optical alignment is to prevent over-specifying the tolerances for precision lens systems, instead assigning the precise adjustment to active alignment which proves to be more cost-effective. Active optical assembly techniques are superior to mechanical lens manufacturing methods and will attain level of centration not even possible with mechanical manufacturing tolerances. The optical method of alignment is an online measurement method, compensating for errors introduced by components fabrication processes.

### 2. Description of the Related Art

Many lens manufacturers use optical measurement instruments for determining centering and alignment errors. The adjustment and centering of optical components has a great impact on image quality and thus is a very important issue. In order to correct the lens decentering, current equipment is based on rotating the lens around the reference axis and creates a circular path on a surface, wherein the radius of the circular path is directly dependent to the amount of decentering. Seldom, the optical axis is created by an electronic autocollimator, which is a part of the total measurement setup. However, in automatic adjusting and bonding devices, the necessity to rotate the lens under investigation is a great obstacle whenever mass production is required. It's the purpose of this invention to offer a solution which will be significantly faster and will not require rotational movements along the optical axis. It is the purpose of the proposed art to eliminate the need of lens rotation along a projected optical axis, significantly improving the process of lens centering and cementing.

### SUMMARY

The present invention provides a method and system for mounting lenses accurately in an optical system. The modern active alignment requires a method of measuring high centering accuracy of the lens in respect to a given optical axis, as well as angular perpendicularity of the lens in respect to some imaging plane. When active alignment is implemented, there is a need of fast measurement of these parameters. To achieve that, current technology requires a setup which includes an autocollimator system and some external means to rotate the lens along its optical axis. This rotating requirement, while accurate, has a drawback of being expensive to implement and difficult when bonding is necessary. Our technology produces a new type of center definition of the lens and its pan/tilt angular deviation by using a method where two laser beams are initially aligned with the autocollimator's line of sight. By analyzing the beam propagation of the two said lasers through the lens, an analysis is derived capable to determine the original lens center and angular deviation. The analysis is performed by a new breed of autocollimators called Total Station Autocollimator, which are capable to perform similar to a standard autocollimator, combined with the capability of laser beam analyzing. As a result, it is possible to perform centering and lens adjustment directions quickly, non-contact, and most importantly without the necessity of lens rotation. After alignment, the lens could be cemented in its best position in relative to the optical setup it is mounted on. Using the characterization of the propagating laser beams, one can determine the amount of lateral offset of the lens in respect with the required center, and also its tilt direction, both corrected by mechanical means under the supervision of the measuring Total Station Autocollimator. If required, additional correction could be performed by same measuring station until the required level of adjustment is achieved. In the following drawings, several layouts for describing the proposed art will be disclosed for better understanding, including detailed prior art description. Embodiments of present invention could use laser sources of different wavelengths, as well as motorized focusing and motorized lens correction to achieve the required result.

It is our purpose to develop an error measuring centering device, based on two parallel calibrated laser beams having a substantial direction parallel to a predetermined line of sight, further optical elements are configured to project said laser beam into a predetermined location and direction in respect to the optical element under examination. A focusable autocollimator with beam profiling capability to analyze the tracing direction of laser beams passing through the lens. One or more processors will be used to control focusing of autocollimator and to calculate directions of propagating lasers and provide error correction information for the lens under examination. Seldom, redirection of laser beams will be performed by retroreflector devices, although redirection could be also performed by splitting the beam from a single laser and creating two parallel beams by reflecting elements, or by using two collinear lasers in conjunction with two reflecting elements to create two parallel beams directed towards the lens under examination. In case a train of lenses disposed in a consecutive way have to be adjusted, we'll move the laser beams and their optical redirecting devices from lens to lens and correcting each lens one after another, starting with the first lens, second lens and so on. Same technology could be applied by directly measuring the laser beams created by the two beams, by a laser beam profiler linearly moved by a stage. Linear movement direction created by the linear stage coincides with the direction of the required optical axis. This technology represents a different method of performing centering of optical elements for the industry and laboratory usage.

### BRIEF DESCRIPTION OF THE DRAWINGS

FIG. 1 is a schematic illustration of prior art centering technique.

FIG. 2 is a schematic of the proposed system, wherein two lasers are projected into the lens active surface using a pair of retro-reflectors.

FIG. 3 is a schematic of the proposed system, wherein a single laser is projected by means of beam splitter and roof prism.

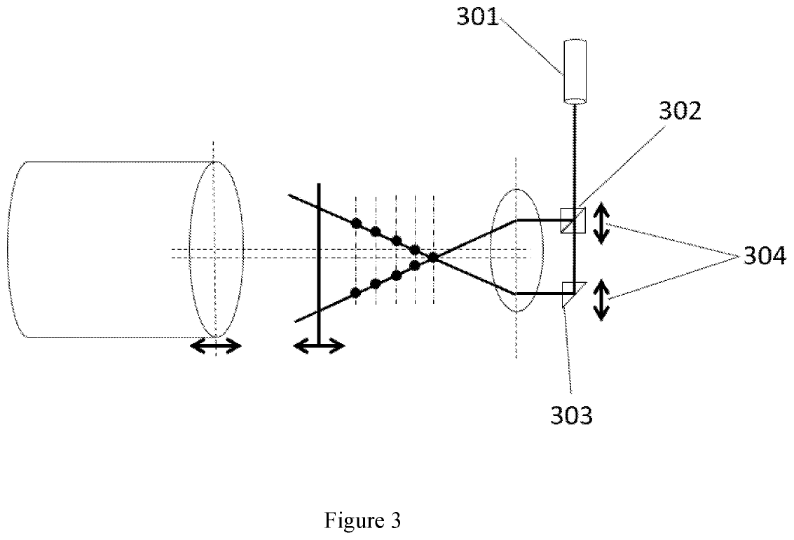

FIG. 4 is a schematic of the proposed system, wherein two lasers are projected by means of prism element.

FIG. 5 is a schematic of the proposed system for an application where several lenses should be centered in a sequential way.

FIG. 6 is a schematic system where said Autocollimator is replaced by a laser beam profiler mounted on a linear stage.

### DETAILED DESCRIPTION OF THE DRAWINGS

The current art of measuring the centration with an Electronic Autocollimator is very effective, especially when combined with micro-controller calculation ability. Although effective and accurate, the method identifies the centering error of each individual lens by physically rotating the lens, usually on precise air-bearing with very low runout errors. This procedure is both expensive and delaying production process. Moreover, when calculating lens centering error, it is necessary to focus of the center of curvature of each surface, rotate it, and calculate the centering error by using optical calculation including curvature, type of glass, thickness and so on.

Examples of embodiments are illustrated by the accompanied drawings. Said drawings will be described, including specific details to facilitate the understanding of embodiments. However, it is apparent to one of ordinary skill in the art, the various descriptions could be implemented without the specific details. The used terminology for specific embodiments is used for better understanding and is not intended to limit the described art.

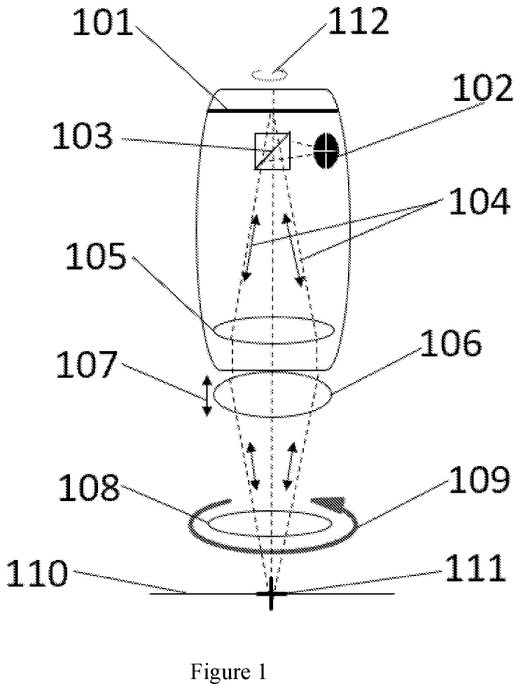

Reference of prior art technology will be made in respect with FIG. 1, wherein the present disclosure will be made to embodiment examples which their illustrations will follow.

FIG. 1 describes by a schematic way the current art of centration measurement; in practice it is possible to measure in this way one or more lenses disposed as an optical assembly. Here an autocollimator projecting illuminated cross-like reticle through a beam splitter and an objective optics is used to project the produced cross through the lens under examination wherein the back reflected cross is recollected by the same objective and displayed on an imaging device. Rotating the lens under observation will create a similar rotation on said imaging device unless the rotation axis is perfectly parallel with the lens optical axis. Amount of deviation is directly linear to the decentering. The 101 surface represents an imaging device, usually a mosaic type of CMOS with multiple pixels. 102 is back illuminated to project the cross depicted on its surface towards an optical Beamsplitter denoted as 103, further propagating to lens 105 which is the objective lens. Furthermore, the objective lens collimates the projected cross through a focusing element 106, which by linear movement denoted as 107 can focus the beam through lens 108 on the reflected surface 110. The created image of illuminated cross 102 is denoted as 111, and back reflected through the same ray tracing which is denoted as 104 since it's representing the bidirectional propagation of light through the system. On said 101 detector the back-reflected cross is imaged, and when lens 108 is rotated in the direction of the arrow 109 a similar tracing direction will be created on the detector surface and will rotate according to 112 direction. If the system is perfectly aligned, the radius of rotation will be zero. If not, it will have an actual dimension. Correcting and centering the lens nullifies the rotational radius. This prior art lacks the measurement capability of adjusting and centering without physical rotation of the lens under examination. It is the purpose of the disclosed art to offer a new technology capable of centering and adjustment of optical axis.

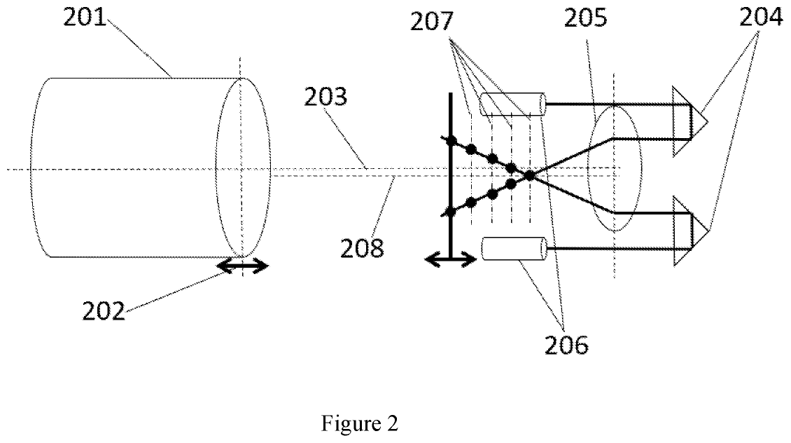

In FIG. 2, the disclosed art is using a Total Station Autocollimator 201 featuring a capability of focusing back and forth to a preselected distance while perfectly retaining its optical axis 203 direction. Moreover, at specific focus distance it has the capability to analyze laser beam profiling at this distance including their location in respect with said optical axis. For characterization of the lens' angular direction and its offset from perfect center to pre-calibrated to be parallel to autocollimator's line of sight which also represents the required direction of optical lens alignment are denoted as 206. The projected laser will reach two retroreflectors denoted by 204, which will back reflect the laser into the lens under examination denoted as 205. The lens will focus the laser beams into its focal point and will propagate in a cone around the lens' line of sight. By focusing said autocollimator onto several consecutive planes denoted as 207, both the line of sight of said lens system and direction will be reconstructed. This reconstructed line of sight is denoted as 208. To correct deviations, the lens will be moved up and down as well as pan/tilt until the calculated line of sight of the lens coincides with the projected line of sight of said autocollimator. Focusing function of autocollimator is schematically shown by 202. This procedure will align the lens to required line of sight, both in centering, as well as pan/tilt directions. Achieving this goal will be the culmination of the adjustment procedure and next stage could be bonding of lens to a specific housing.

Yet another embodiment having the same purpose but with a different projection of laser beams into the examined optical element is disclosed. This embodiment differs by replacing the lasers from FIG. 2 with a new laser denoted as 301, wherein its beam is split into two by Beamsplitter 302, further beam reflected towards the lens by prismatic element 303. The distance between the two beams could be adjusted by moving Beamsplitter 302 in respect to prismatic element 303 to create a different distance in between. This movement is denoted as 304 and adds some flexibility, enabling measurement of different size lenses.

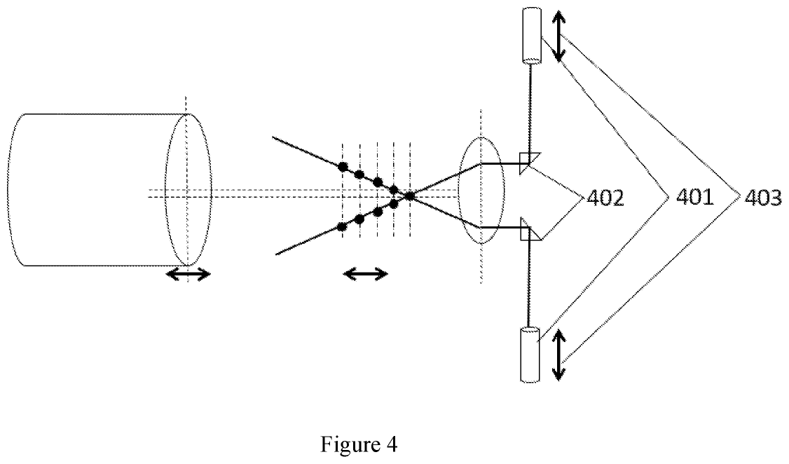

Yet another variation of previous embodiment is displayed in FIG. 4. Here two lasers are used to project their beams into the lens under examination by two prismatic elements or mirrors and the whole procedure is repeated. The two lasers denoted as 401 are redirected by reflection at an angle of 90 degrees 402, to reach the lens surface in a similar matter with the previous embodiments to be further processed, similar to the analysis conducted in previous embodiments. The laser and its reflecting mirror could be moved to change the distance between the two projected rays to adapt to different lens sizes. This movement is denoted as 403.

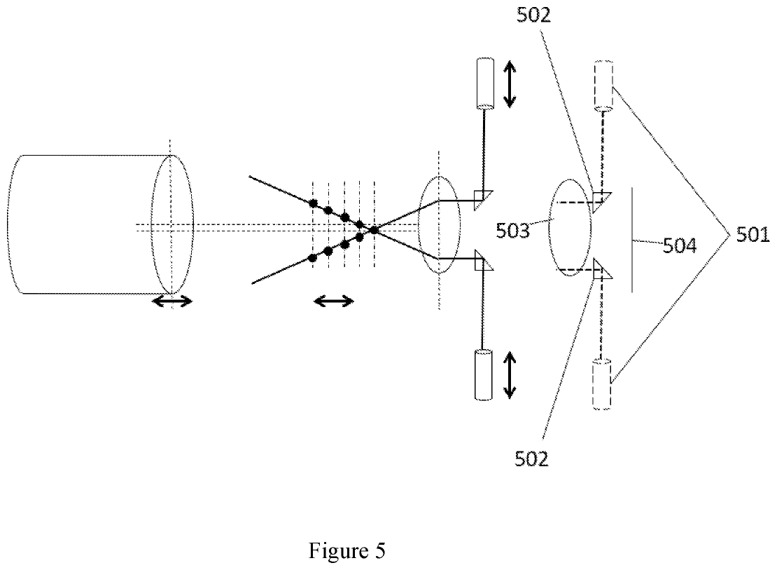

FIG. 5 describes yet another embodiment for adjustment of multiple lenses arranged in consecutive positions. As previously, we start with the first lefthand lens and adjust it first. Then we move the lasers and their reflecting optical elements to the second lens and project the beams through first and second lenses where the analysis is similarly performed as described in previous embodiments. Doing that, we adjust step-by-step each lens across a train of lenses disposed consecutively, until the whole system is adjusted. The new position for the second lens is denoted by 501 and 502 which is deployed after the second lens denoted as 503. 504 represents the possible position of an imaging detector to complete a full imaging system, including camera and its lenses.

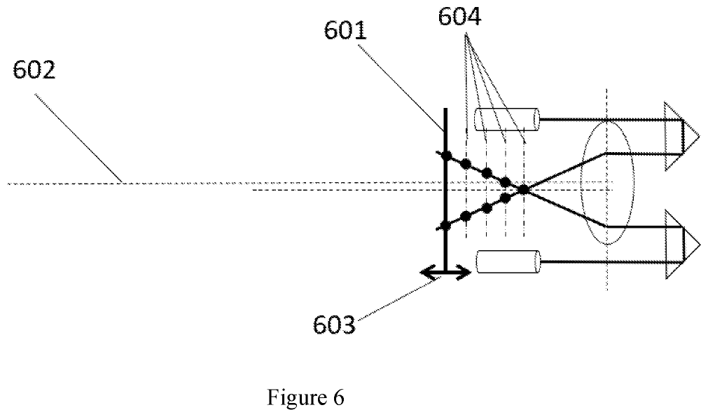

FIG. 6 is a schematic representation of yet another embodiment wherein said autocollimator system is replaced by a laser beam profiling device, denoted as 601. Said laser beam profiler is linearly moved along the ideal line of sight denoted as 602 and the movement direction is denoted as 603. The movement scans different locations 604 along the propagation line and is analyzed location-wise by the laser beam profiler, reconstructing the same information as previously provided by the focusing autocollimator.

1. A measurement error centering device, comprising:
two parallel calibrated laser beams having a substantial direction parallel to a predetermined line of sight configured to be projected into the lens element;
optical elements configured to project the laser beams into a predetermined location and direction in respect with said lens element;
a focusable autocollimator with beam profiling capability to analyze the tracing direction of laser beams passing through the lens; and
one or more processors to control focusing of autocollimator and to calculate directions of propagating lasers and provide error correction information for the lens under examination.

2. A measurement error centering device according to claim 1, where the laser redirection is performed by a retroreflector device.

3. A measurement error centering device according to claim 1, where redirection is performed by splitting the beam from a single laser and creating two parallel beams by reflecting elements.

4. A measurement error centering device according to claim 1, where two collinear lasers are used in conjunction with two reflecting elements to create two parallel beams directed towards the lens under examination.

5. A measurement error centering device according to claim 1, where performing adjustment of a train of lenses disposed in a consecutive way, by moving the laser's beam from lens to lens and correcting each lens one after another.

6. A measurement error centering device according to claim 1, where said autocollimator is replaced by a laser beam profiler equipped with a linear stage.

7. A method for correcting centering errors of lenses, comprising:
two parallel calibrated laser beams having a substantial direction parallel to a predetermined line of sight configured to be projected into the lens element;
optical elements configured to project the laser beams into a predetermined location and direction in respect with said lens element;
a focusable autocollimator with beam profiling capability to analyze the tracing direction of laser beams passing through the lens; and
one or more processors to control focusing of Autocollimator and to calculate directions of propagating lasers and provide error correction information for the lens under examination.

8. The method according to claim 7, where the laser redirection is performed by a retroreflector device.

9. The method according to claim 7, where redirection is performed by splitting the beam from a single laser and creating two parallel beams by reflecting elements.

10. The method according to claim 7, where two collinear lasers are used in conjunction with two reflecting elements to create two parallel beams directed towards the lens under examination.

11. The method according to claim 7, where performing adjustment of a train of lenses disposed in a consecutive way, by moving the laser's beam from lens to lens and correcting each lens one after another.

12. The method according to claim 7, where said autocollimator is replaced by a laser beam profiler equipped with a linear stage.
